(19) United States
(12) Patent Application Publication
(10) Pub. No.: US 2002/0141083 A1
(43) Pub. Date: Oct. 3, 2002

(54) Prism for portable optical device for producing wide-angle big-size virtual image of a picture from mini-size display

(75) Inventor: Chiao-Hsiang Chen, Taipei (TW)

Correspondence Address: David E. Dougherty, Dennison, Schultz & Dougherty, 612 Crystal Square 4, 1745 Jefferson Davis Highway, Arlington, VA, 22202, US

(73) Assignee: E-Pin International Tech Co., Ltd.

(21) Appl. No.: 09/820,910

(22) Filed: Mar. 30, 2001

(51) Int. Cl. G02B 27/14

(52) U.S. Cl. 359/837; 359/831; 359/631

(57) ABSTRACT

A prism for a portable optical device is provided. The optical device is used for producing a wide-angle big-size virtual image of a picture from a mini-size high-resolution display and is usually used at an eye relief of only a few centimeters by wearing it on eyes or held closely to eyes with a hand. With the prism of the optical device, a magnified virtual image of the picture on the small display is projected onto a position beyond a distance of distinct vision of the user, so that the user could utilize a mini-size display and other video and audio instruments carried along the user to enjoy a picture on a wide-angle and big-size screen. An eye-side optical surface of the prism is coated with a reflective coating over an upper area above a maximum elevation angle of the user's vision, so that light beams enter the prism and reach the upper area at a small incident angle are directly reflected by the reflective coating and the upper area of the eye-side optical surface of the prism is not necessarily designed to have the ability of total internal reflection. This allows an improved image quality even the size of the display is further reduced.

### BACKGROUND OF THE INVENTION

The present invention relates to a prism for a portable optical device for producing a wide-angle big-size virtual image of a picture from a mini-size display, and more particularly to a prism that is applied with a reflective coating over an upper area of an eye-side optical surface thereof above a maximum elevation angle of a user's vision, so that the quality of the virtual image produced by the optical device can be enhanced and the clearness of the produced wide-angle big-size virtual image can be maintained even the size of the display is further reduced.

When using a mini-size high-resolution display that is usually worn at a user's eyes, an optical device is needed to project a virtual image of a picture in the mini display to a position beyond a distance of distinct vision of the user, which is normally 2 meters or above. It is preferable to project the virtual image to a screen more than 60″ (inch) in size. That is, the screen is preferably 48″ in width and 36″ in height to meet the ratio of width to height of 4:3, so that a diagonal line thereof is at least 60 inches in length for a user to comfortably view the virtual image.

The entire optical device is to be used at an eye relief of only a few centimeters by, for example, wearing it on eyes or holding it closely to eyes with a hand. An optical device worn on eyes would inevitably form a burden to the user. Therefore, there have been various researches for finding different optical structures to constitute unique and good optical devices for such purpose. In the optical devices developed in early stages, either a reflecting mirror is added to a traditional reflection-type eyepiece system or a concave reflection mirror is used along with a spectroscope, so that a so-called birdbath structure is provided to integrate the installation of the display and decrease a moment and load endured by the user at eyes wearing the optical device. There is another type of optical device for such purpose having a so-called pancake structure. In this type of optical device, a total optical path is increased through on-axis back and forth reflection to effectively reduce the moment and load endured by the user at the eye wearing the optical device. In a further type of the optical device for such purpose, a polarization plate is omitted from the on-axis back and forth reflection to provide an improved off-axis back and forth reflection that also effectively increases the total optical path to reduce the moment and load endured by the user at the eye wearing the optical device. The off-axis back and forth reflection structure is optically classified as an asymmetrical system. Since there is a big difference in the optical paths for forming images in two orthogonal directions, asymmetrical optical elements such as off-axis holographic optical elements or Anamorphic asphere optical elements having different curvatures on orthogonal axes are needed. And, in the off-axis back and forth reflection structure, the use of a prism structure is more effective than using reflection in air to lengthen the focal distance of an optical system, and the unreasonable structure of a display extended into the optical system can be avoided.

A prism structure currently available for the optical device of such purpose has a shape similar to that of a prism 10 shown in FIGS. 1 and 2. The prism 10 includes at least a first optical surface A facing toward a display D, a second optical surface B facing toward a user's eye E, and a third optical surface C facing away from the user's eyes E and having a plated coating to serve as a reflection mirror. A light beam emitted from the display D is refracted at the first optical surface A and enters into the prism 10. The light beam entered the prism 10 reaches the second optical surface B and is totally reflected due to an air interface outside the second optical surface B. That is, the second optical surface B has the ability of Total Internal Reflection (TIR). When the light beam reflected from the second optical surface B reaches the third optical surface C that serves as a reflection mirror, it is reflected toward the second optical surface B and is refracted and then passes through the second optical surface B to reach the user's eyes E. In the optical device with the above-described prism 10, there is a serious off-axis condition and the aberration between two images formed in two orthogonal directions is big. This is because the prism 10 must be designed for light beams to pass the first optical surface A and reach the second optical surface B at an incident angle that allows the light beams reached the second optical surface B to be totally internally reflected at the air interface and then be reflected by the third optical surface C toward the user's eyes E. Although the aberration in two orthogonal directions can be somewhat corrected through the three asymmetrical optical surfaces A, B and C, the correcting effect reduces with increased tilting degree of the optical surfaces. Particularly when the high-resolution display is getting smaller and smaller in its size, for example, reduced from 1.3″ to 0.7″, 0.6″ or even only 0.5″, while a resolution thereof is to be increased, it is very difficult to maintain or improve the virtual image quality with the prism currently available for the optical device of such purpose.

Therefore, it is desirable to adjust the structure of currently available optical device for such purpose so that the tilting degree of the optical surfaces are advantageously reduced to decrease the aberration caused by reflections and refractions of the light beams in the optical device.

To solve the above problem, it is tried by the inventor to improve the prism so that it is not necessary for the entire eye-side optical surface of the prism to have the TIR ability.

### SUMMARY OF THE INVENTION

A primary object of the present invention is to provide a prism for a portable optical device for producing a wide-angle big-size virtual image of a picture from a mini-size display, wherein the prism is applied with a reflective coating over an upper area of an eye-side optical surface thereof above a maximum elevation angle of a user's vision, so that a curved surface in that coated area does not have to completely reply on the total internal reflection at an air interface and a light beam reached the coated area at a reduced incident angle may still be totally internally reflected. Thereby, the quality of virtual image produced by the optical device can be improved, allowing a wide-angle and big-size virtual image having high clearness to be produced from a mini-size display having an even reduced size.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a side view showing light paths of light beams in an optical device having the prism of present invention;

FIG. 2 is a perspective of the prism shown in FIG. 1;

FIG. 3 is a perspective showing a maximum elevation angle of a user's vision when viewing a virtual image produced through the present invention;

FIG. 4 is a side view of FIG. 3; and

FIG. 5 is a perspective of a prism according to an embodiment of the present invention.

### DETAILED DESCRIPTION OF THE PREFERRED EMBODIMENTS

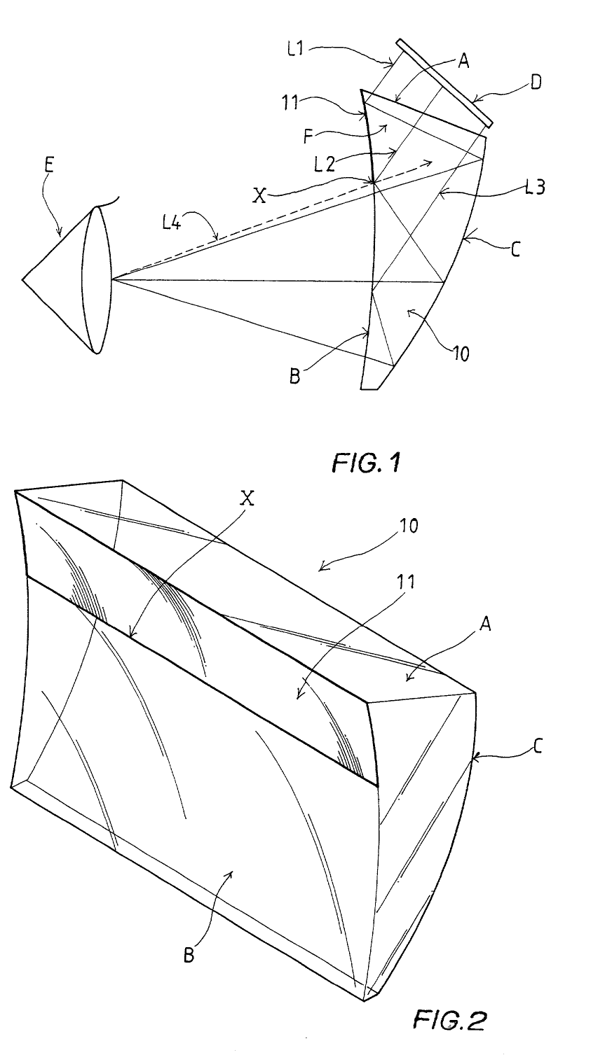

Please refer to FIG. 1 that shows a prism 10 currently available for a portable optical device for producing a wide-angle big-size virtual image of a picture from a mini-size display D. As described above, the prism 10 includes first, second and third optical surfaces A, Band C, respectively. Among these optical surfaces, optical surface B is the eye-side optical surface and is completely transparent. Light beams reached the second optical surface B are refracted and then pass the second optical surface B to reach a user's eyes E. The prism 10 utilizes a tilting relationship among the optical surfaces A, B and C to enable light beams L1, L2 and L3, that are used to generally represent an entire picture on the display D herein, emitted from the display D to pass the first optical surface A and reach the second optical surface at an incident angle that allows the light beams reached the second optical surface B to be totally internally reflected at an air interface outside the second optical surface B and then be reflected by the third optical surface C toward the user's eyes E.

However, an upper area F of the second optical surface B of the currently available prism 10 has a tilting degree that is designed to improve the quality of virtual image produced by the optical device. With such tilting degree in the upper area F of the second optical surface B, the light beam L1 reaches the upper area F at an incident angle that does not enable the light beam L1 to be totally internally reflected at the air interface. In other words, the incident angle of the light beam L1 at the second optical surface B (that is, an angle contained between the light beam L1 and a normal line of the second optical surface B) is so small that the light beam L1 is refracted at the second optical surface B and then passes through the same instead of being totally internally reflected at the air interface. More specifically, the upper area F of the second optical surface B does not have the TIR ability and therefore prevents the optical device from producing an absolute wide-angle virtual image from the mini display D. When the display D has an even reduced size, the upper area F also prevents the virtual image produced by the optical device from having a high resolution. An attempt of eliminating the above-mentioned disadvantages by improving the design of the three optical surfaces A, B and C would require a lot of time and high cost.

Means adopted by the present invention to solve the above-mentioned problems is to apply a reflective coating 11 over an area of the second optical surface B that is above an intersection line X at where the optical surface B intersects with a visual line L4 defining a maximum elevation angle θ of the user's eyes E viewing the display D. When a light beam emitted from the display D is refracted at the first optical surface A and then enters the prism 10 to reach an area of the second optical surface B below the intersection line X, it is first reflected toward the third optical surface C through total internal reflection and then be reflected toward the second optical surface B to reach the user's eyes E. However, when a light beam emitted from the display D passes the first optical surface A and enters the prism 10 to reach an area of the second optical surface B above the intersection line X, it can be totally reflected toward the third optical surface C by the reflective coating 11 even if an incident angle of the light beam at the second optical surface is not a big incident angle that is otherwise required to achieve the total internal reflection. The light beam reflected by the reflective coating toward the third optical surface C is then reflected by the third optical surface C toward the user's eyes E. Since the incident angle of the light beam reaching the upper area of the second optical surface B can be reduced, both the tilting degree and the aberration can be reduced accordingly to enable improved quality of produced virtual image. Thus, the function of the prism 10 is effectively enhanced in a very simple manner.

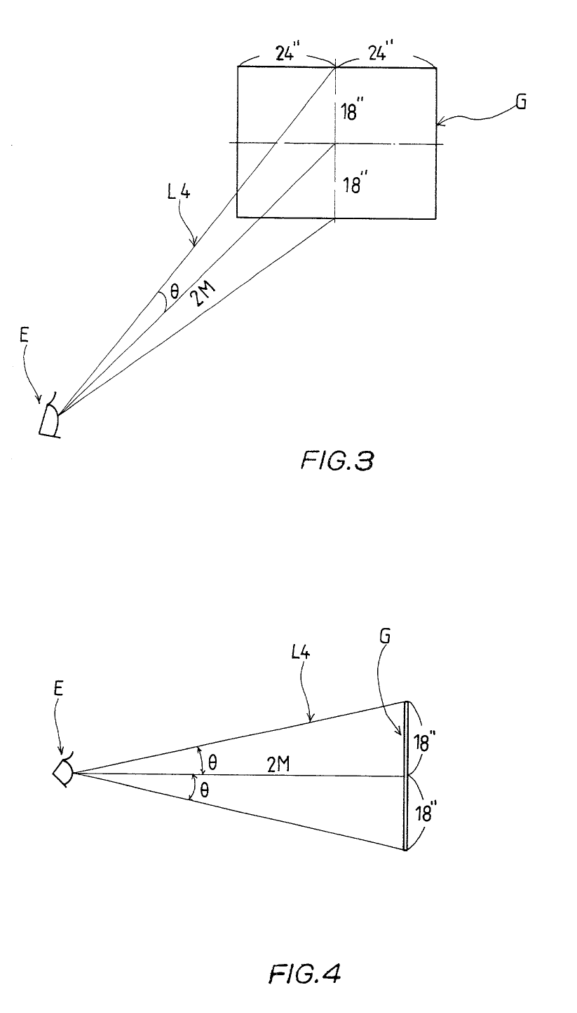

Please refer to FIGS. 3 and 4. A virtual image of a picture in the display D is produced at a position beyond a distance of distinct vision of the user, which is normally 2 meters or more from the user's eyes E, so that a user could comfortably view the virtual image. The virtual image is preferably produced on a screen G of at least 60″ in size located at a distance of 2 meters from the user's eyes E. That is, the screen G has a size of at least 48″ in width, 36″ in height, and 60″ in diagonal line. In the illustrated drawings, angle θ is the maximum elevation angle of the user's eyes E viewing the display D, and L4 is the visual line at the maximum elevation angle θ. It is possible to determine the intersection line X of the visual line L4 and the second optical surface B during the stage of designing the optical device and the prism 10 and to apply the reflective coating 11 over the area of the optical surface B above the intersection line X.

It is most preferable to apply the reflective coating 11 over the entire area of the second optical surface B above the intersection line X to obtain an optimal working state for the prism 10. However, it is also possible to apply the reflective coating 11 only over a part of the area of the second optical surface B above the intersection line X. That is, a lower boundary of the area with the reflective coating 11 is located above the intersection line X without contacting with the latter. Although an optical effect that can be provided by a prism 10 being partially applied with reflective coating 11 in the area of the optical surface B above the intersection line X is less better than that can be provided by a prism 10 being fully applied with reflective coating 11 in the area of the optical surface B above the intersection line X, the optical effect of the prism 10 with partially coated upper area above the intersection line X is apparently improved as compared with the prism 10 that is not applied with the reflective coating 11 at all. Thus, a prism 10 being partially applied with reflective coating 11 in the area of the optical surface B above the intersection line X is considered as an equivalent of the present invention.

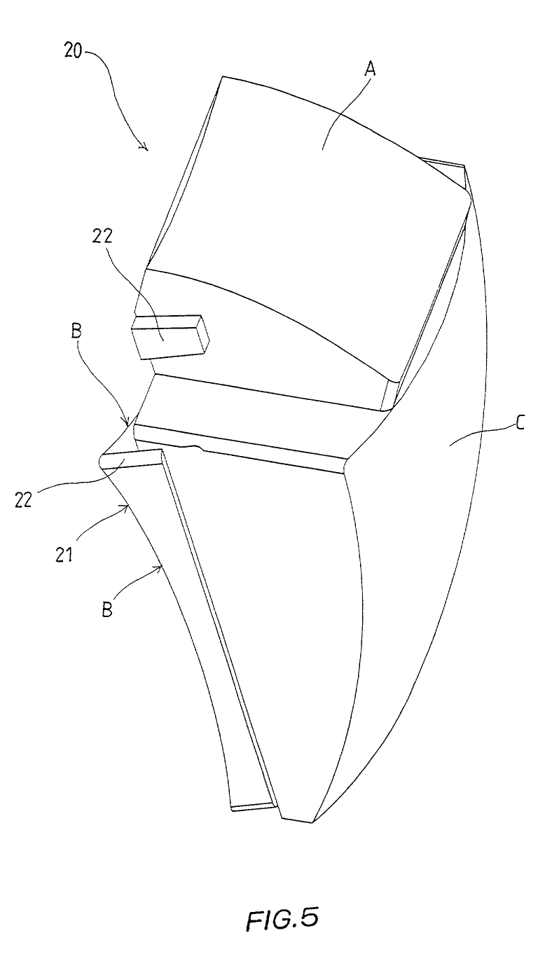

FIG. 5 shows a prism 20 according to the present invention in the form of a test sample and having a basic structure similar to the prism 10. That is, the prism 20 also includes three major optical surfaces A, B and C and is characterized in that the optical surface B has a specific area at an upper part thereof being applied with a reflective coating 21. As to changes made in the shape of appearance of the prism 20 as shown in FIG. 5, such as the provision of bent edges 22, they are designed to match with jigs of various testing instruments. Such bent edges 22 could be trimmed or removed after tests and before formal mass-production of the prism 20. Since such changes in the appearance of the prism are not subject matters of the present invention, they are not discussed in details herein.

What is claimed is:

1. A prism for a portable optical device for producing a wide-angle big-size virtual image of a picture from a mini-size display, said prism comprising at least a first optical surface facing toward said display panel, a second optical surface facing toward a user's eyes, and a third optical surface facing away from the user's eyes and having a plated coating to serve as a reflecting mirror; said prism being characterized in that said second optical surface facing toward the user's eyes includes an upper area being applied with a reflective coating, so that when a light beam emitted from said display enters said prism and reaches said upper area of said second optical surface, said light beam is reflected by said reflective coating toward said third optical surface without the need to reach said upper area of said second optical surface at a big incident angle that is otherwise required for said light beam to be totally internally reflected in said prism.

2. The prism for a portable optical device as claimed in claim 1, wherein said upper area of said second optical surface being applied with said reflective coating is located above an intersection line at where said second optical surface intersects with a visual line defining a maximum elevation angle of the user's eyes viewing said display.

3. The prism for a portable optical device as claimed in claim 2, wherein said intersection line is also a lower boundary of said upper area of said second optical surface being applied with said reflective coating.

4. The prism for a portable optical device as claimed in claim 2, wherein said intersection line is lower than a lower boundary of said upper area of said second optical surface being applied with said reflective coating.
